(19) United States
(12) Patent Application Publication
(10) Pub. No.: US 2007/0065142 A1
(43) Pub. Date: Mar. 22, 2007

(54) PC camera direction positioning structure concealed in filling toy

(76) Inventor: Hui-Hu Liang, Siu Shui Hsiang (TW)

Correspondence Address: TROXELL LAW OFFICE PLLC, SUITE 1404, 5205 LEESBURG PIKE, FALLS CHURCH, VA, 22041, US

(21) Appl. No.: 11/230,486

(22) Filed: Sep. 21, 2005

(51) Int. Cl. G03B 19/00; G03B 17/48; G03B 29/00

(52) U.S. Cl. 396/429

(57) ABSTRACT

A PC camera direction positioning structure concealed in filling toy, which is to put plastic sectional parts together in order, of which one end is ball-shaped body and another end is ball groove, ball-shaped body is embedded into ball groove, and to rabbet three-way or four-way joints at turning point so as to make a man-shaped plastic connector; this connector is then wrapped into a filling toy assembled PC camera, the filling toy can sit or directly grovel and grasp any position of monitor based on suitable adjustment, lens of PC camera fixed at top head of filling toy can shoot at correct direction, therefore, this structure can further improve external appearance of PC camera that can take shooting in different modes and angles in practice.

### BACKGROUND OF THE INVENTION

1) Field of the Invention

This invention relates to PC camera direction positioning structure concealed in filling toy, wherein plastic connector is put together with plastic sectional part and multi-way joint, which is wrapped in a filling toy assembled PC camera and lens fixed at its head, so that the filling toy can be positioned in any pose and provide web shooting in different directions and angles.

2) Description of the Prior Art

As long as the improvement and change of technology in every passing day, Internet communication has been becoming an important commodity of modern people, application of computer is no longer to process files and receive & dispatch E-mail, you can directly make web communication, have video chat and hold video conference depending on shooting of PC camera and related computer software, which has been favored by individual or company because of its clear and convenient video effect, and also because of its lower communication fees; however, web video communication must first be shot with PC camera, loud speaker records voice, the related computer software then processes the collected images and voices and transmits the processed images and voice to remote terminal, therefore, PC camera plays an very important role in such type of communication; At present, the PC camera for sale, except paying attention to its resolving power, more consideration is taken in its positioning structure so that PC camera can make perfect shooting. However, according to the current invention, most of PC cameras are fixed at computer table or monitor by clamping holder or clamping lock, their application may be restricted by shape and thickness due to the distance between open ends of clamping holder and clamping lock, especially, shapes of monitor are not confined in rectangle in recent years, but it has been the trend to design in special shape and geometrical curve, thereby, the old positioning method of current PC camera are no longer practical and required for further improvement.

### SUMMARY OF THE INVENTION

1. Problems to Solve

(1) Above described PC camera, no matter positioned by clamping holder or clamping lock, which often utilize clamping mouth in certain clamping gap to clamp or lock up directly, however, it is often inconvenient to assemble and operate due to the fixed gap of clamping mouth, therefore, such frame is not practical.

(2) Either clamping holder or clamping lock, which must be kept parallel with clamping plane so as to clamp or lock up stably and tightly. However, the new products have been developing as long as the change of technology in every passing day, manufacturers have made breakthrough in the design of shape of products besides innovation made in the functions in order to motivate consumer's purchase desire. Manufacturers have focused on changes of monitor and mouse of computer, shapes of monitor have no longer confined in rectangle, so, the current clamping holder or clamping lock of PC camera cannot clamp or lock up tightly as required.

(3) To clamp onto monitor of computer with clamping holder or clamping lock may produce clamp force to monitor, thereby, it is easy to damage appearance of structure, and to cause inconvenient use and impact on the aesthetic feeling of appearance.

2. Solutions:

a. This invention is to make plastic connector without any limitation in length with plastic sectional parts, of which one end is ball shaped and another end is of ball groove based on the positioning mode that ball shaped body can embed with ball groove, so that it can satisfy all requirements in practical application.

b. The overall turning of plastic connector can let its structure complete best multi-directional seizing and positioning in accordance with shape and angle of application area, therefore, it is applicable in any place and can provide stable positioning and practical efficiency.

c. The assembling structure of this invention may not make any damage to the clamping position (such as monitor of computer or tabletop), but also provide a visual aesthetic feeling to user, so that application of PC camera may be more interesting.

### BRIEF DESCRIPTION OF THE DRAWINGS

FIG. 1 is the exploded view of the structure of this invention.

FIG. 2 is the cross-section and curving sketch map of the structure of this invention.

FIG. 3 is the cubic molding structure of this invention and its sketch map to conceal in a filling toy.

FIG. 4 is a baby-shaped PC camera assembled with the structure of this invention.

FIG. 5 is the application sketch map of this invention.

### DETAILED DESCRIPTION OF THE INVENTION

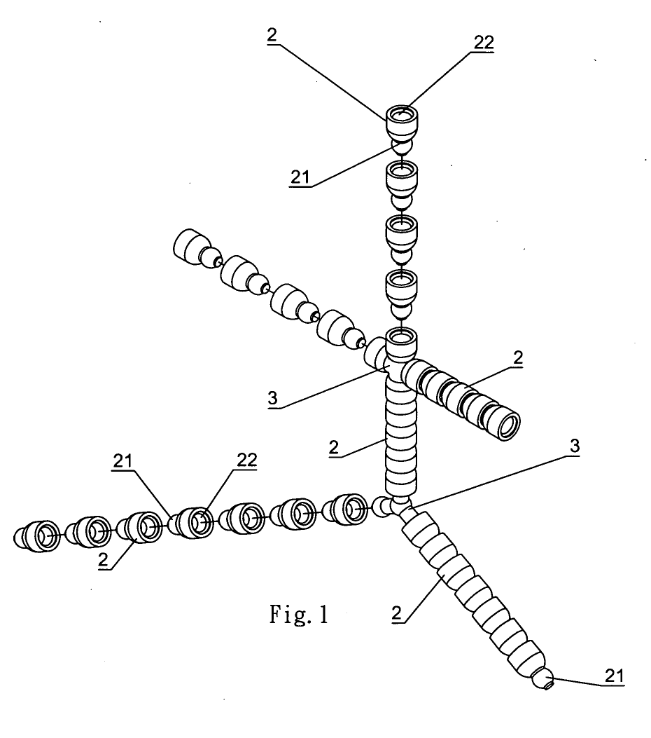

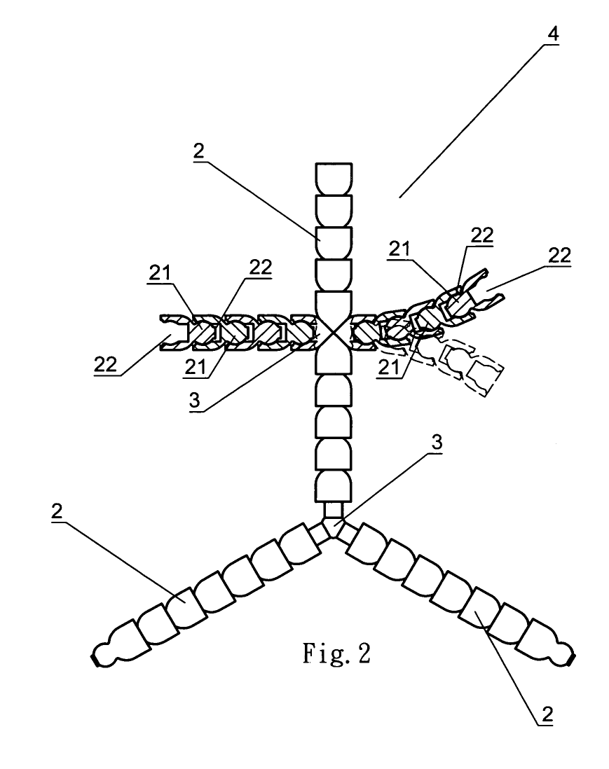

First of all, please refer to FIG. 1 and FIG. 2, this invention is to put the plastic sectional parts together in order, of which one end is ball-shaped body 21 and another end is ball groove 21, ball-shaped body 21 is embedded into ball groove 22, and to rabbet three-way or four-way joints 3 at turning point so as to make a man-shaped plastic connector 4 (refer to FIG. 2 for detail).

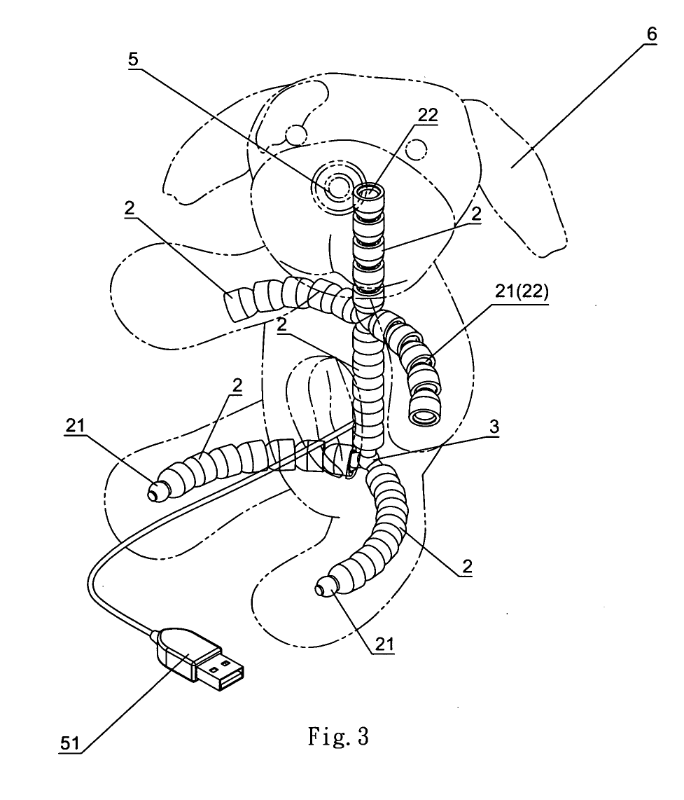

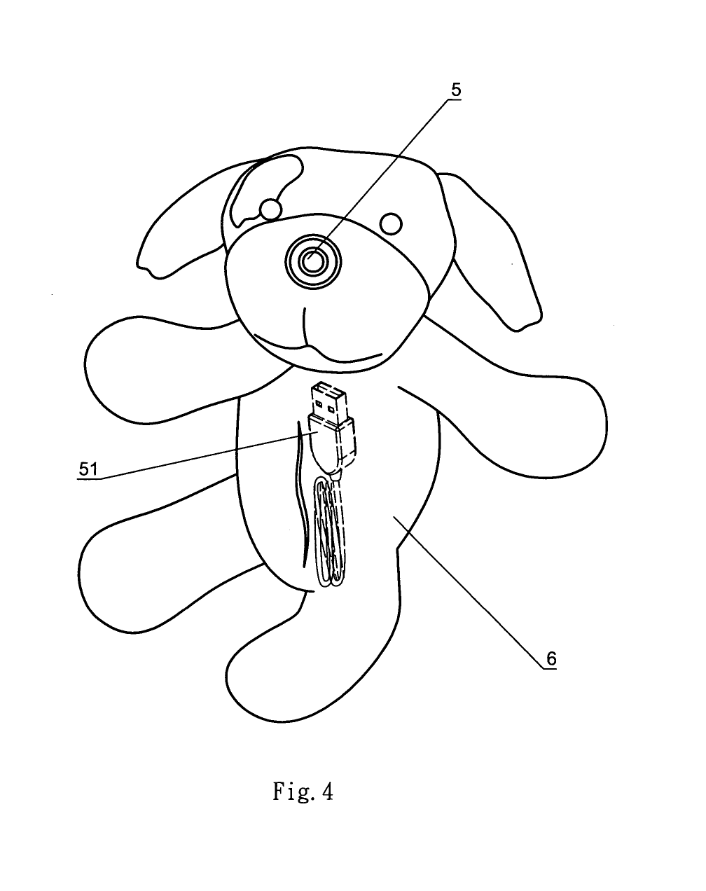

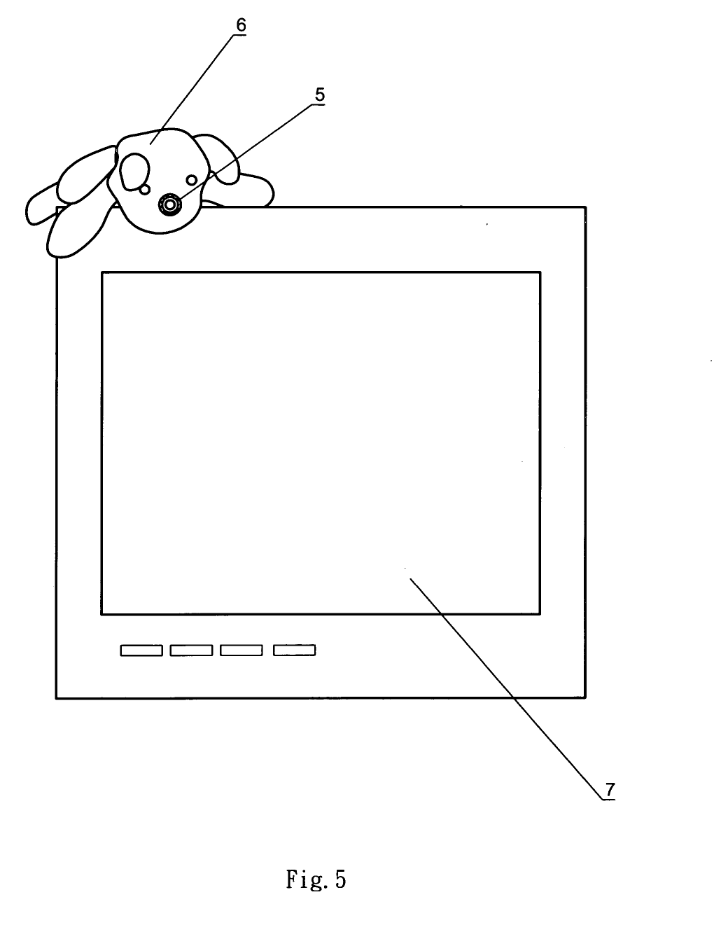

Secondly, please refer to FIG. 3, FIG. 4 and FIG. 5, plastic connector 4 of this invention can be wrapped into filling toy 6 assembled PC camera 5 and become the support frame concealed in filling toy 6 (refer to FIG. 3), PC camera concealed in filling toy 6 is connected to the control system of host computer with connection plug 51, so that it can take instant shooting while communicating (refer to FIG. 4 for structure); Based on suitable adjustment, the filling toy can sit or directly grovel and grasp any position of monitor 7, lens of PC camera fixed at top head of filling toy 6 can shoot at correct direction by easy adjustment of plastic connector 4, therefore, it may improve the external appearance of PC camera and take shooting in different modes and angles in practice (refer to FIG. 5 for application status).

What is claimed is:

1. A PC camera direction positioning structure concealed in filling toy, which is to put the sectional plastic parts together in order, of which one end is ball-shaped body and another end is ball groove, ball-shaped body is embedded into ball groove, and to rabbet three-way or four-way joints at turning point so as to make a man-shaped plastic connector, which is wrapped into a filling toy assembled PC camera, the filling toy can sit or directly grovel and grasp any position of monitor based on suitable adjustment, lens of PC camera fixed at top head of filling toy can shoot at correct direction, therefore, this structure can further improve external appearance of PC camera that may take shooting in different modes and angles in practice.

2. The PC camera direction positioning structure concealed in filling toy as claimed in claim 1, wherein this structure is applicable for any shape of filling toy.

3. The PC camera direction positioning structure concealed in filling toy as claimed in claim 1, wherein this structure can select plastic sectional parts to assemble connector in desired length according to practical requirements.
